(19) United States
(12) Patent Application Publication
(10) Pub. No.: US 2004/0050344 A1
(43) Pub. Date: Mar. 18, 2004

(54) Safety water-heater valve adjustment

(76) Inventors: Alessandro Toniolo, Torre (IT); Stefano Zanella, Montebelluna (IT)

Correspondence Address: RATNERPRESTIA, P O BOX 980, VALLEY FORGE, PA, 19482-0980, US

(21) Appl. No.: 10/271,195

(22) Filed: Oct. 15, 2002

(30) Foreign Application Priority Data
Sep. 16, 2002 (IT) PD2002A000236

(51) Int. Cl. F02M 37/04; F22B 37/42

(52) U.S. Cl. 122/504; 122/507

(57) ABSTRACT

A knob adjustment device, particularly for adjusting the temperature in valve units of water-heating apparatus is described. The knob device is mounted so as to be rotatable about a rotation axis in a stationary housing of the valve unit and comprises safety means for the unidirectional restraint of the knob relative to the housing so as to oppose rotation of the knob in a first direction of rotation about the said axis, the knob being free to rotate in the opposite direction of rotation.

The present invention relates to a knob adjustment device, in particular for adjusting the temperature in water-heating apparatus, according to the preamble to the main claim.

The invention relates in particular to the field of water-heating apparatus such as, for example, domestic water heaters, in which there is a thermostatically-controlled valve unit provided with a knob adjustment device for adjusting the temperature of the water to be heated.

An example of an adjustment device of this type is described in the Applicant's patent application No. PD2000A000185.

The above-mentioned knob adjustment device is arranged to incorporate the operative control functions by means of which the user can permit lighting of the pilot-light and shutting-off of the gas-flow and, in addition, can select the desired water-temperature value. These functions can be selected by the user by rotation of the above-mentioned knob device.

Within this technical field, a need has arisen to ensure safety locking of the knob to prevent its accidental rotation during the operation of the water-heater, which could lead to undesired and, in some cases, dangerous increases in the water temperature. A typical condition to be prevented is that in which accidental operation of the knob, for example, by children, may lead to an increase in the water temperature such that it is dangerous in use.

A main object of the invention is to provide a knob adjustment device of the above-mentioned type which is designed structurally and functionally to satisfy the need indicated, ensuring safety locking of the knob when the water-heater is in operation, and which can prevent undesired accidental rotation.

Another object is to provide a knob adjustment device in which rapid operation of the knob from the safety locking position towards a switched-off position or, in any case, a position in which the water temperature is reduced, is permitted so as to ensure that the device is made safe quickly if conditions dangerous to the user should arise.

These and other objects which will be made clear below are achieved, according to the present invention, by a knob adjustment device, in particular for water-heating apparatus, having the characteristics set out in the appended claims.

The characteristics and the advantages of the invention will become clearer from the following detailed description of a preferred embodiment thereof, given with reference to the appended drawings, provided by way of non-limiting example in which:

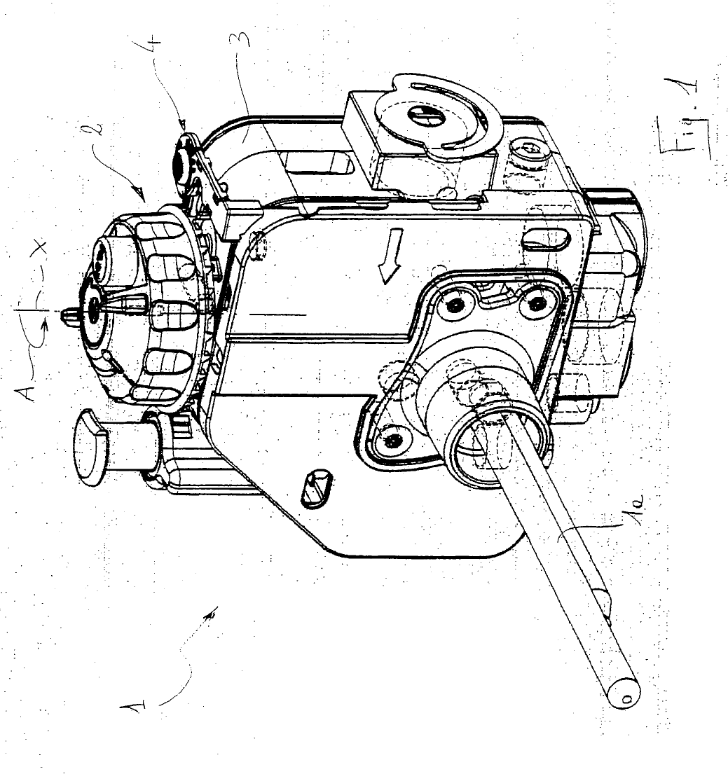

FIG. 1 is a schematic, perspective view of a valve unit equipped with a knob adjustment device formed in accordance with the present invention,

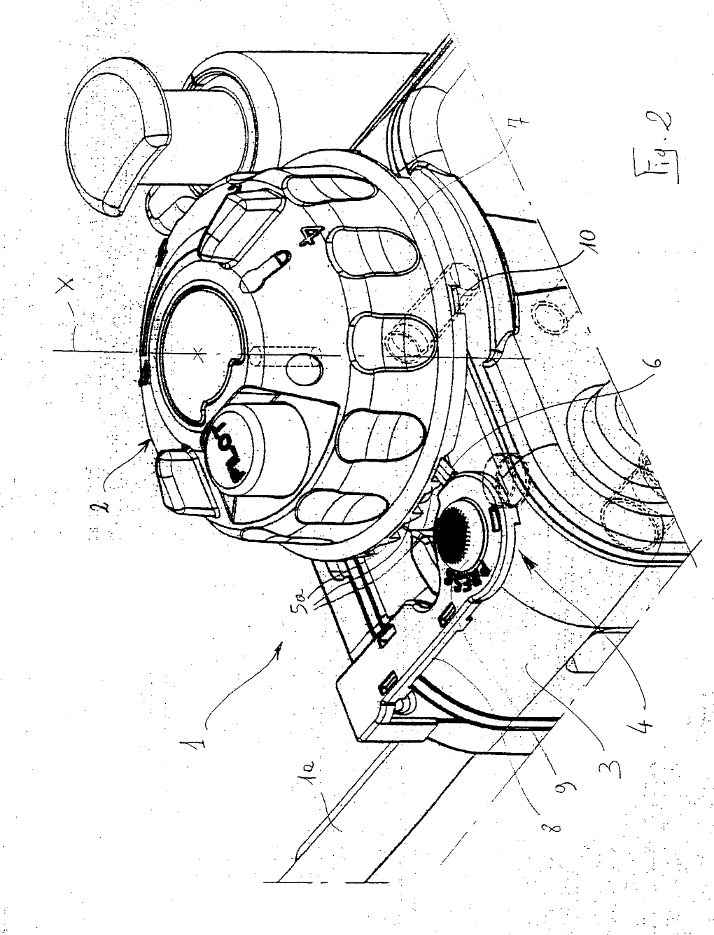

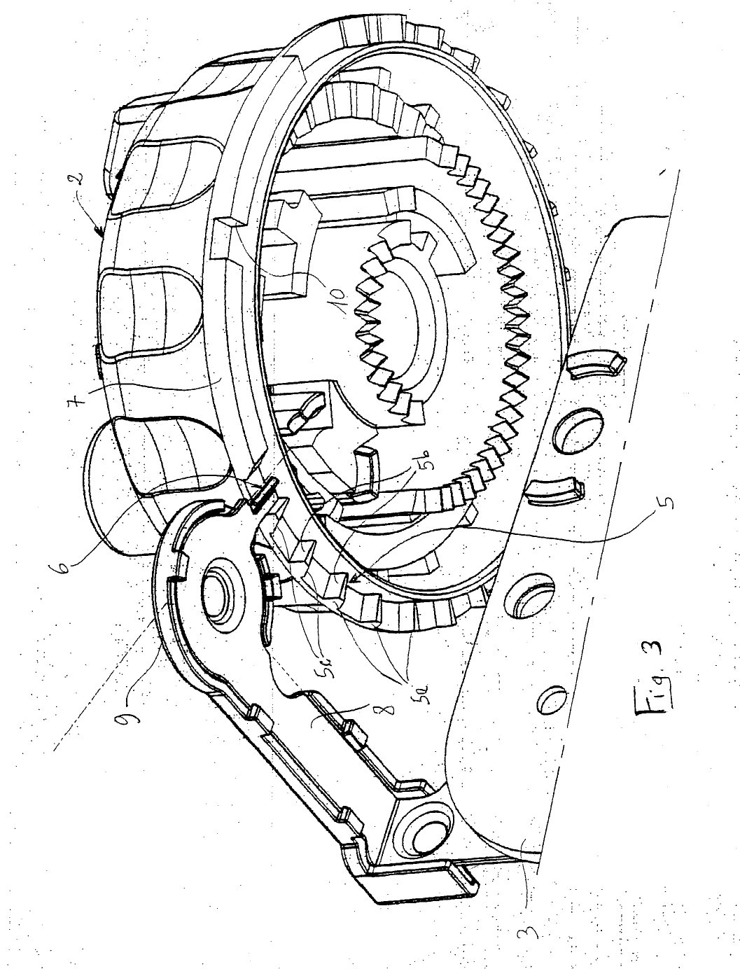

FIGS. 2 and 3 are partial perspective views showing a detail of the device of the previous drawing on an enlarged scale,

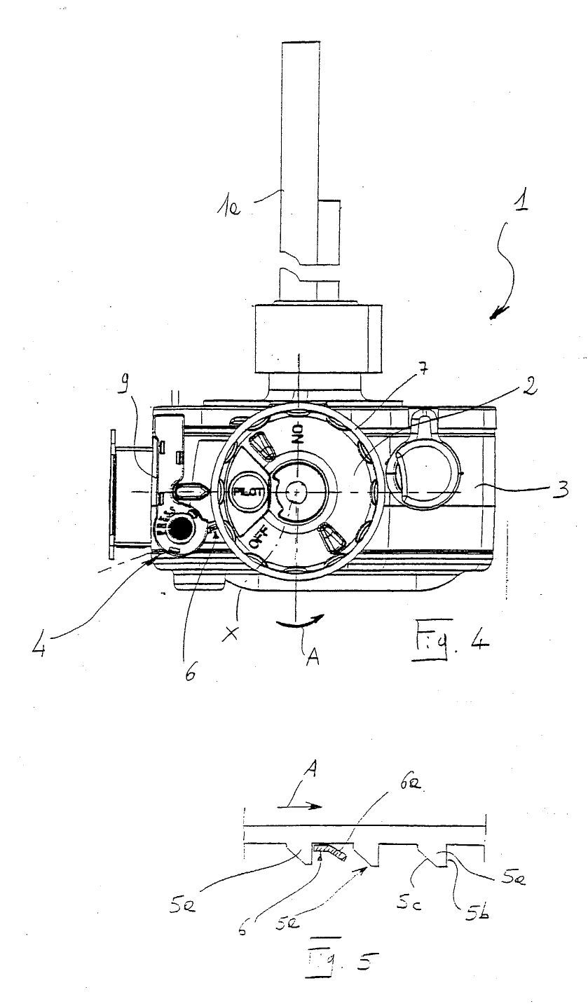

FIG. 4 is a plan view of the valve unit of the previous drawings from above, and

FIG. 5 is a partial schematic view showing a detail of the previous drawings on an enlarged scale.

With reference to the drawings mentioned, a valve unit equipped with a knob adjustment device 2 formed in accordance with the present invention is generally indicated 1. The valve unit described in this embodiment of the invention is of the thermostatically-controlled type and is intended mainly for the adjustment and control of the water temperature in water-heating apparatus, for example, in domestic water heaters for heating washing water. The device according to the invention is, however, intended for use in other fields, although the field indicated represents a preferred choice.

The valve unit 1 has an element 1a which is sensitive to temperature variation and which is operatively connected to a closure member, not shown, that can be operated so as to open/close a respective valve seat (also not shown) provided inside the unit. The knob adjustment device 2 is mounted so as to be rotatable about a rotation axis X in a box-like housing 3 of the valve unit 1 and incorporates all of the adjustment functions provided for in operation, that is, enabling the pilot light to be lit (by means of a push-button 4), completely shutting off the gas-flow (OFF point of the knob), as well as adjusting the temperature of the water being heated. The adjustment in order to set gradually increasing water temperatures takes place by rotation of the knob 2 in an anticlockwise direction about the axis X as seen in FIG. 4 (the direction indicated by the arrow A).

According to a principal characteristic of the invention, the knob device 2 comprises safety means, generally indicated 4, which can restrain the knob 2 in the preselected adjustment position to prevent accidental rotation thereof such as to lead to dangerous increases in the temperature of the water being heated, as will be described in detail in the following description.

In greater detail, the restraining means 4 comprise a set of teeth 5 on the knob 2 and a tooth-shaped retaining element 6 which is fixed firmly to the housing 3 and can engage the set of teeth 5. The set of teeth is a set of face teeth and comprises a plurality of teeth 5a extending along an angular sector of a projection 7 protruding from the body of the knob 2. The teeth 5a have substantially sawtooth-like profiles each having a face 5b and an inclined ramp-like side 5c which are connected to one another and are of a shape such that, when the retaining tooth 6 is engaged with the set of teeth 5, it is in abutment with the face 5b of the corresponding tooth in order to prevent rotation of the knob 2 in the direction of rotation A, restraining it in the position previously set.

The retaining tooth 6 is also urged into engagement with the set of teeth 5 by resilient means including a resiliently deformable plate 8 which, for example, is made of harmonic steel and is restrained at one of its ends by the housing 3 of the valve unit and carries the retaining tooth 6 at its opposite end. The tooth 6 is advantageously formed integrally with the plate by shaping of the corresponding end thereof.

By virtue of the inclined ramp-like shape of the sides of the teeth 5, the retaining tooth 6 is free to pass over the teeth 5a, jumping along their sides, against the resilient force of the plate, to allow the knob to rotate freely in the opposite direction to that of the arrow A, that is, in the direction corresponding to the setting of decreasing temperature values. To facilitate the sliding movement over the sides of the teeth 5, the retaining tooth has an inclined portion 6a which can interfere with the ramp-like sides of the teeth 5.

The retaining tooth 6 is also arranged to be selectively releasable from the set of teeth 5, upon an intentional operation, so as to allow the knob 2 to rotate in the direction of rotation A to enable the desired temperature to be set. For this purpose, the retaining tooth 6 is associated with a push-button-like element 9 for moving the retaining tooth 6 away from the position of engagement with the tooth 5, in opposition to the resilient force of the plate 8.

The push-button-like element 9 is advantageously formed in a covering coating of plastics material of the plate 8.

Moreover, when the knob 2 is in the OFF position, its rotation is arranged to be locked as a result of the engagement of the retaining tooth 6 in a recess 10 formed in the annular projection 7 of the knob.

In operation, starting from the OFF position of the knob 2, upon depression of the push-button 9, the tooth 6 is released from the recess 10 and the knob can be rotated freely to the position in which the pilot light can be lit, in which the tooth 6 is moved into engagement with the first tooth of the set of teeth 5 (FIG. 2). A further depression of the push-button after the pilot light has been lit releases the rotation of the knob to enable the desired angular position corresponding to the preselected water temperature value to be reached. In the preselected angular position, by virtue of the engagement of the retaining tooth 6 in the set of teeth 5, accidental rotation of the knob 2 in the direction of rotation A (anticlockwise in FIG. 4) is prevented; if this rotation were permitted, it could lead to an undesired increase of the water temperature, possibly resulting in conditions dangerous to the user. Rotation of the knob in the direction A can be permitted only as a result of an intentional depression of the push-button 9.

Moreover, rotation of the knob in the opposite direction to that of the arrow A from the preselected adjustment position is permitted, without any operation of the push-button 9, by virtue of the sliding of the retaining tooth by jumping over the sides of the teeth 5. This operation enables the knob to be rotated quickly, in conditions of danger, in the direction in which the water temperature is reduced, in order to make the water-heating apparatus safe quickly and immediately, possibly extinguishing the burner (OFF position). It will thus be noted that this action does not require any pressure on the push-button 9.

The invention thus achieves the objects proposed, affording the advantages mentioned above over known solutions.

1. A knob adjustment device, in particular for adjusting the temperature in valve units of water-heating apparatus, the knob device being mounted so as to be rotatable about a rotation axis in a stationary housing of the valve unit, characterized in that it comprises safety means for the unidirectional restraint of the knob relative to the housing so as to oppose rotation of the knob in a first direction of rotation about the said axis, the knob being free to rotate in the other, opposite direction of rotation.

2. A device according to claim 1 in which the restraining means are selectively releasable to allow the knob to rotate in the first direction of rotation.

3. A device according to claim 1 to claim 2 in which the restraining means comprise a set of teeth on the knob and a retaining tooth which is fixed firmly to the housing and can engage the set of teeth.

4. A device according to claim 3 in which the retaining tooth is urged resiliently into engagement with the set of teeth.

5. A device according to one or more of the preceding claims, in which the first direction of rotation of the knob is associated with upward temperature adjustments so that the knob is restrained with regard to the first direction of rotation to prevent increases in the temperature due to accidental rotation of the knob.

6. A device according to claim 3 in which the set of teeth is a set of face teeth extending along a preselected angular sector of the knob, the retaining tooth being movable so as to be released from the set of teeth in a direction substantially parallel to the axis of rotation, in opposition to resilient means.

7. A device according to claim 3 or claim 6 in which the teeth of the set of teeth have substantially sawtooth-like profiles each having a face and an inclined ramp-like side which are connected to one another, so that the retaining tooth abuts the faces of the teeth in order to restrain the knob with regard to the first direction of rotation and is free to pass over the teeth by sliding along their ramp-like sides, in opposition to the resilient means, to allow the knob to rotate freely in the second direction of rotation.

8. A device according to claim 6, in which the resilient means comprise a resiliently deformable plate restrained, at a first end, on the stationary housing and carrying the retaining tooth at the opposite, second end.

9. A device according to one or more of claims 3 to 8 in which the retaining tooth is formed by shaping of-the second end.

10. A device according to one or more of claims 3 to 9 in which a push-button-like element is provided, associated with the retaining tooth, for moving the retaining tooth away from the set of teeth, against the resilient force of the plate.

11. A device according to claim 10 in which the push-button is formed in a covering coating of the plate.
